(19) United States
(12) Patent Application Publication
(10) Pub. No.: US 2016/0332846 A1
(43) Pub. Date: Nov. 17, 2016

(54) UNIFORM FOOTPRINT MULTI-WHEEL END TRUCK FOR A CRANE

(71) Applicant: Mi-Jack Products, Inc., Hazel Crest, IL (US)

(72) Inventors: John J. Lanigan, Sr., Orland Park, IL (US); Michael Wisniewski, Mokena, IL (US); Robert P. Marcinski, Glenwood, IL (US); Eric Van Gorp, Schererville, IN (US)

(21) Appl. No.: 14/711,320

(22) Filed: May 13, 2015

(51) Int. Cl. B66C 19/00; B66C 9/12

(52) U.S. Cl. CPC B66C 19/002; B66C 9/12

(57) ABSTRACT

According to one aspect, a supporting truck for a crane comprises a load bearing member and a frame rigidly coupled to the load bearing member. A plurality of substantially equally spaced and substantially equally sized wheels is rigidly journaled in the frame at substantially equal heights such that the wheels have a single degree of freedom comprising rotational movement with respect to the frame and the load bearing member. The load bearing member and the frame have a moment of inertia of at least a particular value to cause the wheels to experience substantially equal loading by forces applied to the load bearing member.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### FIELD OF DISCLOSURE

This invention pertains to gantry cranes, overhead cranes, portal cranes, and the like, and, more particularly, to a crane having a multi-wheel end truck.

### BACKGROUND

Cranes of the above type are known in the art and are used to support heavy loads, as such loads are transported, for example, in a rail yard, a shipyard, a factory, etc. Such a crane may include a trolley supported on trolley girders. Ends of the trolley girders may be supported by end trucks that are movable on spaced bridge girders. In some cranes, the bridge girders are supported at each end thereof. In other cranes, the bridge girders may extend beyond support columns or other structural support members such that the girders terminate at cantilevered ends. In either case, the loading applied to the bridge girders determines the required strength thereof, and thus, the amount of material that is required to construct the girders. More material results in increased weight and material costs, which, in turn, results in increased initial and operating costs.

In the case of a crane having cantilevered bridge girders, for example, the distance that the cantilevered end of the girder extends from its closest support is critical as any load or weight positioned on the cantilevered portion of the girder creates a moment with respect to the nearest support (e.g., column, frame, etc.). This moment (i.e., force applied over a distance) is determined by multiplying the weight of the load by the distance between the load and the nearest support member. If the moment created by the load exceeds the capacity of the girder, the girder may deflect, bend, or even fail, possibly causing grave injury to personnel in the area and damage to goods and equipment being transferred.

In order to allow for the movement of heavy loads such as those found in a container rail yard or shipyard, the bridge girders may comprise heavy weight box beams to support the loads. Depending on the length of the cantilever (if present) and the weight of the loads, such girders may become cost prohibitive because of the weight of the girder required to satisfy loading requirements. In order to overcome this problem, either the length of the cantilever must be shortened or eliminated altogether and/or the weight of the load decreased. However, even if the cantilevered sections are eliminated, the remaining sections of the bridge girders must, of course, still be sized to support the expected loading thereon.

Conventional trolley end trucks utilize a plurality of wheels that are mounted at relatively widely spaced locations. In a known end truck design, the wheels are supported by equalizing and/or compensating devices that are pivotable or otherwise movable. The pivoting or other moving action allows the wheels to share the applied loads equally. However, the wide spacing of the wheels results in application of relatively widely spaced point loads where the wheels contact the bridge girder. Also, in the case of cantilevered bridge girders, the overall center of gravity of the end truck is displaced relatively far from the support column closest to the cantilevered girder section. The bridge girder must be designed with these factors in mind so that the bridge girders can safely support all expected loading conditions.

### SUMMARY

According to one aspect, a supporting truck for a crane comprises a load bearing member and a frame rigidly coupled to the load bearing member. A plurality of substantially equally spaced and substantially equally sized wheels is rigidly journaled in the frame at substantially equal heights such that the wheels have a single degree of freedom comprising rotational movement with respect to the frame and the load bearing member. The load bearing member and the frame have a moment of inertia of at least a particular value to cause the wheels to experience substantially equal loading by forces applied to the load bearing member.

According to another aspect, a crane includes first and second spaced bridge members wherein each bridge member extends between an associated pair of supports and the bridge members are parallel to one another. The crane further includes first and second spaced trolley girders and a movable trolley is disposed on the trolley girders. First and second end trucks support first and second ends, respectively, of the first and second trolley girders and the trolley girders extend transversely with respect to the bridge members. Each of the first and second end trucks includes a load bearing member, a frame rigidly attached to the load bearing member, and a plurality of substantially equally spaced and substantially equally sized wheels rigidly journaled in the frame at substantially equal heights. The wheels have a single degree of freedom comprising rotational movement with respect to the frame and the load bearing member, and the load bearing member and the frame have a moment of inertia I at least equal to Mc/f, where M is a load moment on a particular cross section of the load bearing member, c is a distance from a neutral axis of the particular cross section to an extreme fiber of the particular cross section, and f is a given stress magnitude, to cause the wheels to experience substantially equal loading by forces applied to the load bearing member.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a perspective view showing an embodiment of a crane comprising a cantilever gantry crane;

FIG. 1A is a further perspective view of the embodiment of FIG. 1;

FIG. 2 is a fragmentary enlarged perspective view showing one of the end trucks used in the cantilever gantry crane of FIG. 1;

FIG. 3 is a side elevational diagrammatic view of an end truck used in the embodiment of FIG. 1;

FIG. 4 is a perspective view of a further embodiment of a crane that does not have cantilevered sections or portions and which may include the trolley of FIGS. 1-3; and

FIG. 5 is a cross sectional view of a truck comprising a box girder that supports a load.

### DETAILED DESCRIPTION

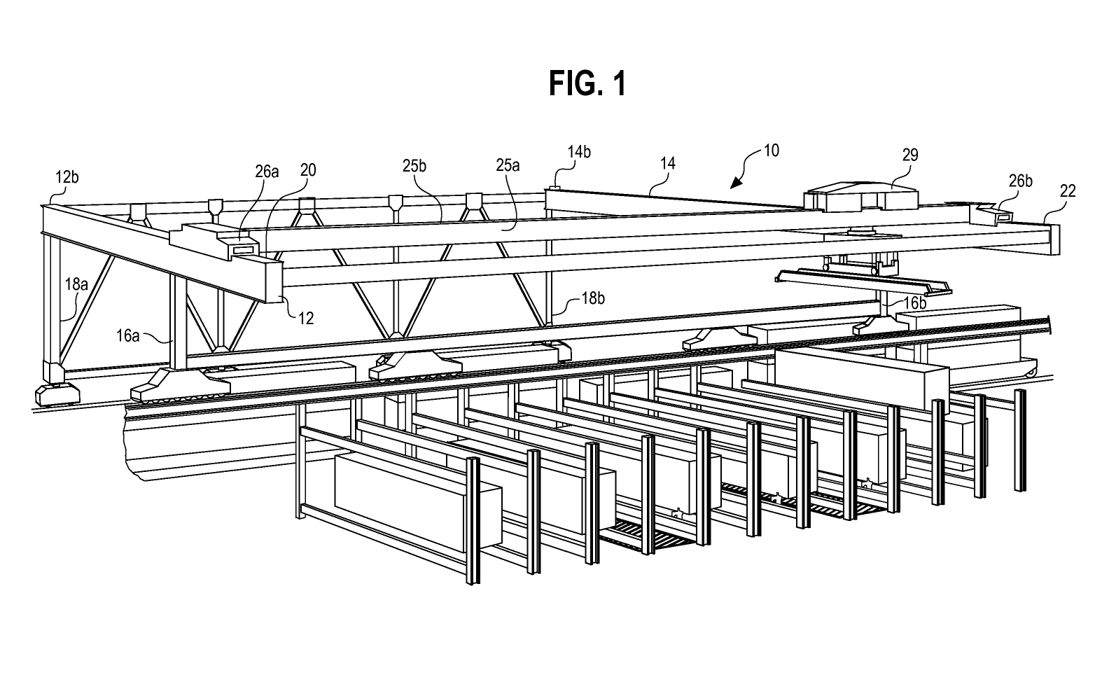

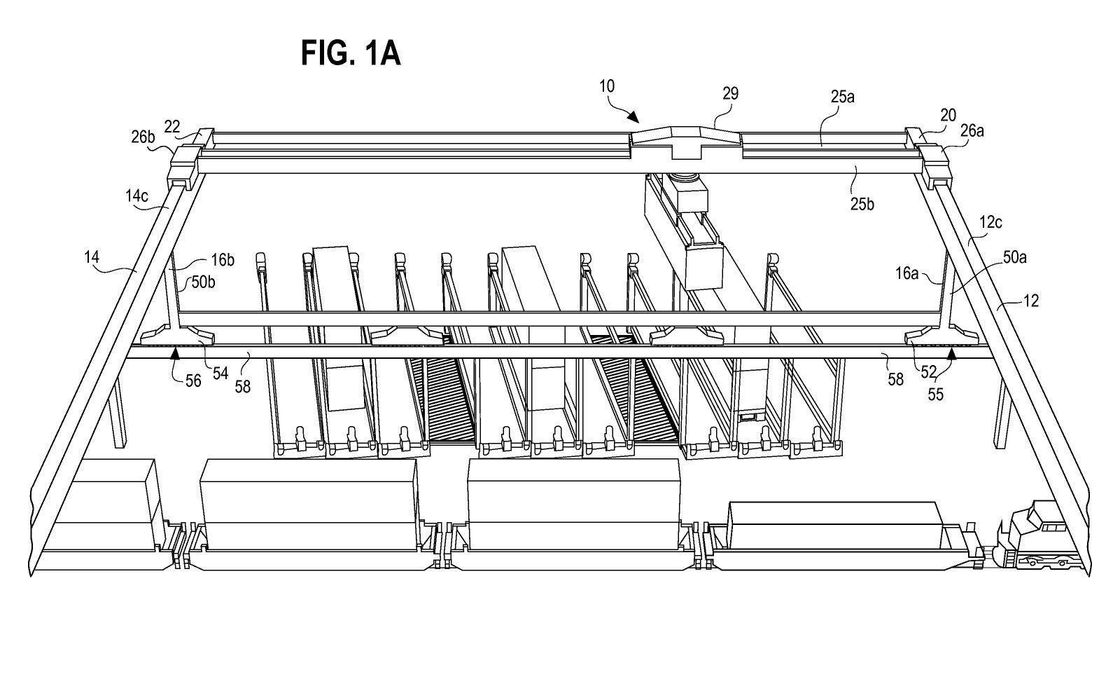

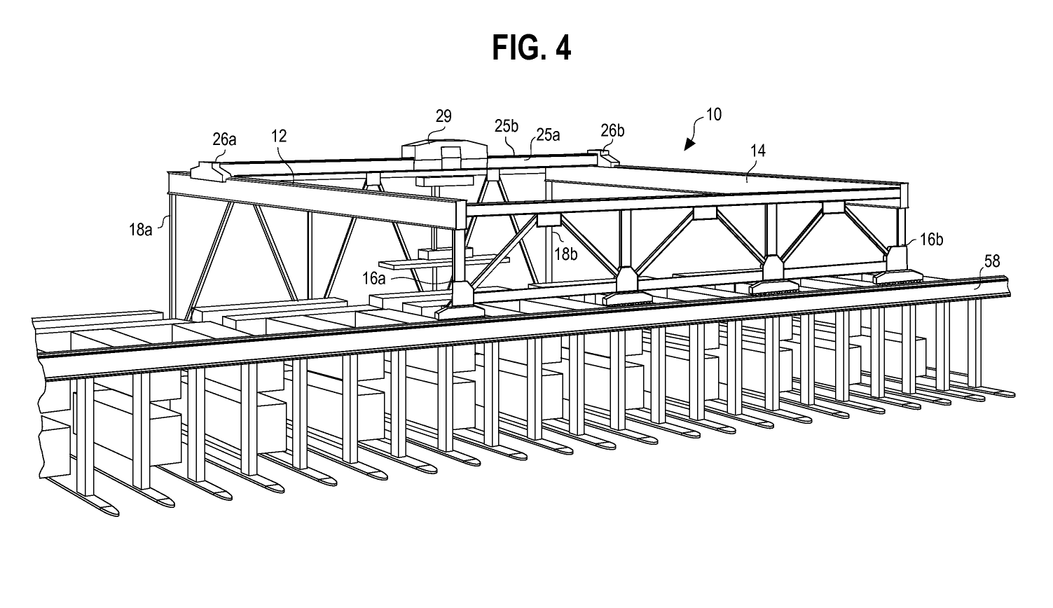

FIGS. 1 and 1A show a crane, more particularly, a cantilever gantry crane 10 comprising first 12 and second bridge girders 14 each of which extends between first and second supports 16a, 18a and 16b, 18b, respectively. In the illustrated embodiment each of the first and second bridge girders 12, 14 terminates in a cantilevered section or portion 20, 22, respectively, that extends outboard of the first supports 16a, 16b, respectively. As noted hereinafter and as seen in FIG. 4, the bridge girders need not have the cantilevered sections or portions 20, 22. In any event, first and second trolley girders 25a, 25b extend transversely between the bridge girders 12, 14 and are supported in spaced relation by supporting trolley end trucks 26a, 26b. Each of the end trucks 26a, 26b is movable along the respective bridge girders 12, 14 on a plurality of wheels 28, respectively (only the wheels 28 of the end truck 26a are visible in the FIGS). A trolley 29 is movable on the trolley girders 25a, 25b between the first and the second bridge girders 12, 14, transverse to the movement of the end trucks 26a, 26b on the bridge girders 12, 14.

In an embodiment, the trolley 29 is movable on the first and second trolley girders 25a, 25b in a direction perpendicular to the longitudinal extent of the first and second bridge girders 12, 14. In such an embodiment, each of the first and second trolley girders 25a, 25b supports one half the weight of a load being transferred by the gantry crane 10.

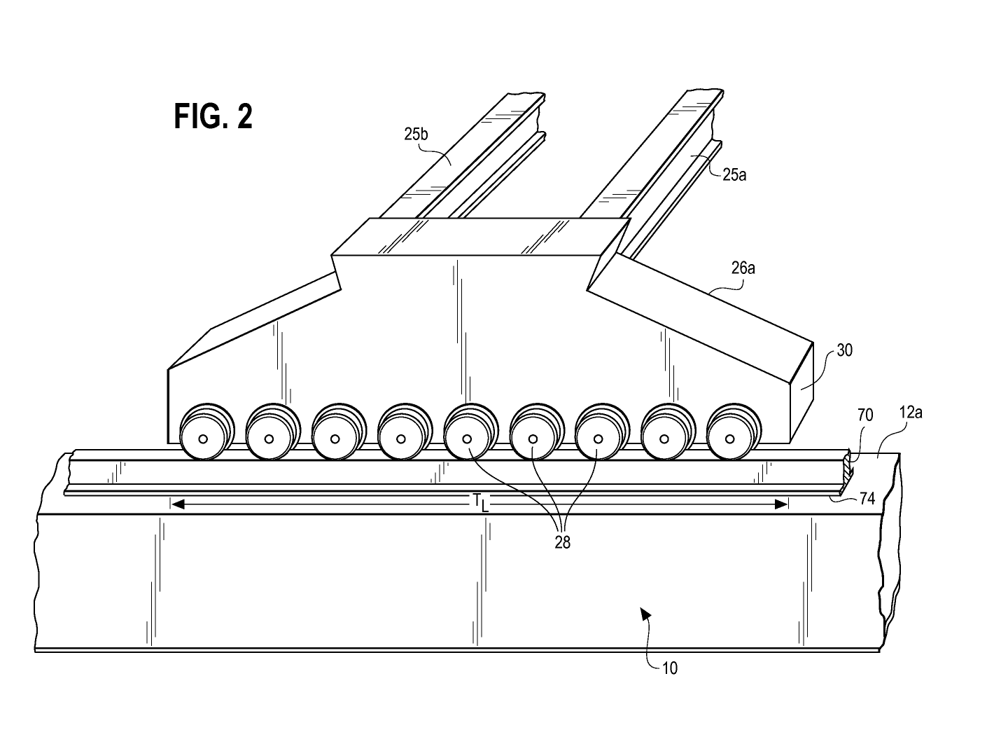

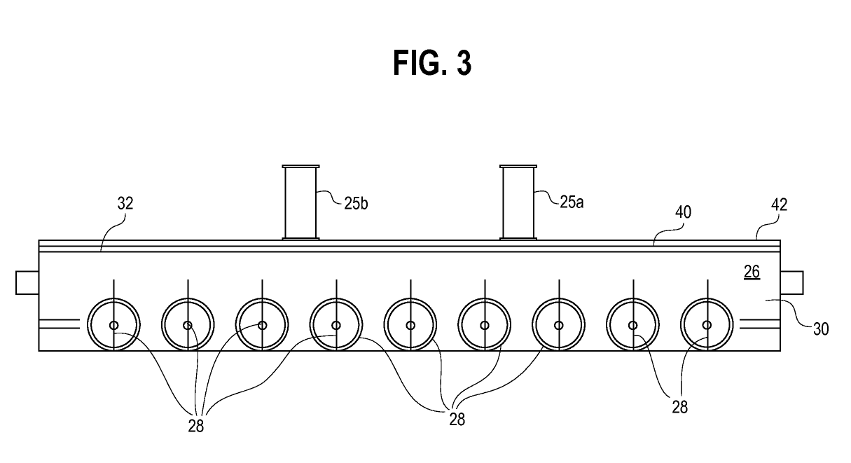

The end trucks 26a, 26b are substantially if not completely identical to one another except that the end truck 26a is a mirror image of the end truck 26b; accordingly, only the end truck 26a will be described in detail herein together with the associated portions of the crane 10. Referring also to FIGS. 2 and 3, the end truck 26a has a length T_{L}, and a frame 30 in which the plurality of wheels 28 is journaled. The wheels 28 are identical or substantially identical to one another in size, shape, and material, and are journaled at equal or substantially equal heights above an upper surface 12a of the bridge girder 12. The wheels 28 are not isolated from one another or from a load bearing surface 32 (seen in FIG. 3) of the end truck 26a by springs, pivoting members, other relatively movable members, or the like. Rather, each wheel 28 is rigidly mounted with respect to the frame 30, and the frame 30 is rigidly mounted to the load bearing surface 32 such that the wheels 28 have only one degree of freedom of movement, i.e., the wheels are only able to rotate relative to the frame 30 and the load bearing surface 32 and are not otherwise movable relative to such structures. Further, the frame 30 is not able to move at all (or is at least substantially immovable) relative to the load bearing surface 32. In addition, the moment of inertia and the stiffness of the load bearing member 32 and the frame 30 are increased, the number of wheels is increased, and the spacing of the wheels is decreased, as noted in greater detail hereinafter. Such an arrangement results in a load supported by the trolley 24 being evenly distributed among each of the plurality of wheels 28 on the end truck 26 and that such loading is applied to the bridge girder 12 over a wheelbase distance. This even distribution of weight on the closely spaced wheels 28 results in a relatively uniform loading of the bridge girder 12 thereby allowing the bridge girder 12 to be designed to have less mass while still adequately supporting the applied loads, leading to reduced initial and operational costs.

Further, in the case of the cantilevered crane of FIGS. 1-3, the distance of the moment arm that results from the weight of the load that is supported by the cantilevered portion 20 is shortened such that the center of gravity C_{G} of the end truck is disposed closer to the first supports 16a, 16b when the end truck 26a is disposed at an end 38 of the cantilevered portion 20. This limits the moment arm applied to the cantilevered portion 20, thereby allowing the mass thereof to be reduced, leading to the desirable decrease in costs as noted above.

In an embodiment, the plurality of wheels on the end truck is mounted adjacent to a support platform 40 to which one or more plates 42, such as steel, or other stiffening plates or other members are secured, such as by welding, to increase the moment of inertia of the load bearing member 32 and frame 30.

Further, as seen in FIG. 1, first ends 12b, 14b of the bridge girders 12, 14 are mounted on the supports 18a, 18b in contact with the ground via wheels, and other sections 12c, 14c, seen in FIG. 1A, are mounted on the supports 16a, 16b. The cantilevered portions 20, 22 are located outboard of the supports 16a, 16b. Other supports may be provided as necessary or desirable. Lower ends 50a, 50b of the supports 16a, 16b are carried by supporting gantry trucks 52, 54 each having pluralities of wheels 55, 56 that rest on a runway beam 58. The gantry trucks 52, 54 are identical or substantially similar to the end trucks 26a, or 26b and are movable along the runway beam 58.

In all embodiments motors are operable by a control to move the trolley 29, the end trucks 26a, 26b and the gantry trucks 52, 54 to transfer loads, such as containers or other items, between locations and/or to move the crane 10.

In one embodiment, each of the cantilevered portions 20, 22 extends at least 50 feet outboard of the supports 16a, 16b. The first and second bridge girders 12, 14 may be of any suitable overall length without departing from the spirit and scope of the invention. For example, in one embodiment, each of the first and the second bridge girders 12, 14 may extend at least 150 feet between the first and the second supports 16a, 18a and 16b, 18b, respectively, and may have a total length of 200 feet. In a particular embodiment, each plurality of wheels 28 of the end trucks 26a, 26b comprises nine wheels, although a greater or lesser number of wheels may be provided, and the wheels simultaneously roll on rails 70 (FIG. 2) disposed atop the first and second bridge girders 12, 14, respectively. Preferably, although not shown, the wheels are flanged on both sides thereof. In an embodiment, relatively soft mounting pads 74 may be disposed between the bridge girders 12, 14 and the rails 70 as shown in FIG. 2 (only one of the rails 70, the mounting pads 74, and the bridge girder 12 are visible in FIG. 2). The wheels 55, 56 of the gantry trucks 52, 54 may similarly roll on one or more rails (not shown) that are disposed on the runway beam 58. One or more relatively soft mounting pads (also not shown) similar or identical to the pads 74 may be disposed between the rail(s) and the runway beam 58. Other similar or identical structures, such as additional trucks and one or more additional runway beams and associated apparatus, may be provided to support and permit movement of the crane 10. The additional trucks may be identical to the trucks 26a, 26b, 52, and 54.

Each truck 26a, 26b, 52, 54 may be any suitable size or shape and may have, for example, a box shaped cross section. The wheels 28, 55, and 56 may be of any appropriate size; however, all of the wheels of each plurality should be of the same size for proper weight distribution, although the wheels of one plurality may be of a different size, shape, and/or material than the wheels of one or more of the other pluralities. For example, in one embodiment, each wheel of the pluralities of wheels 28, 55, and 56 has a diameter of 15 inches, and each wheel of the pluralities of wheels 28, 55, and 56 is spaced from the center of adjacent wheels by about 1.5 feet. In a particular embodiment, the standard deviation of the loads on the wheels of a plurality of wheels is no greater than about 2%.

In an embodiment, each truck 26a, 26b, 52, 54 has a moment of inertia I for an allowable stress magnitude f of at least:

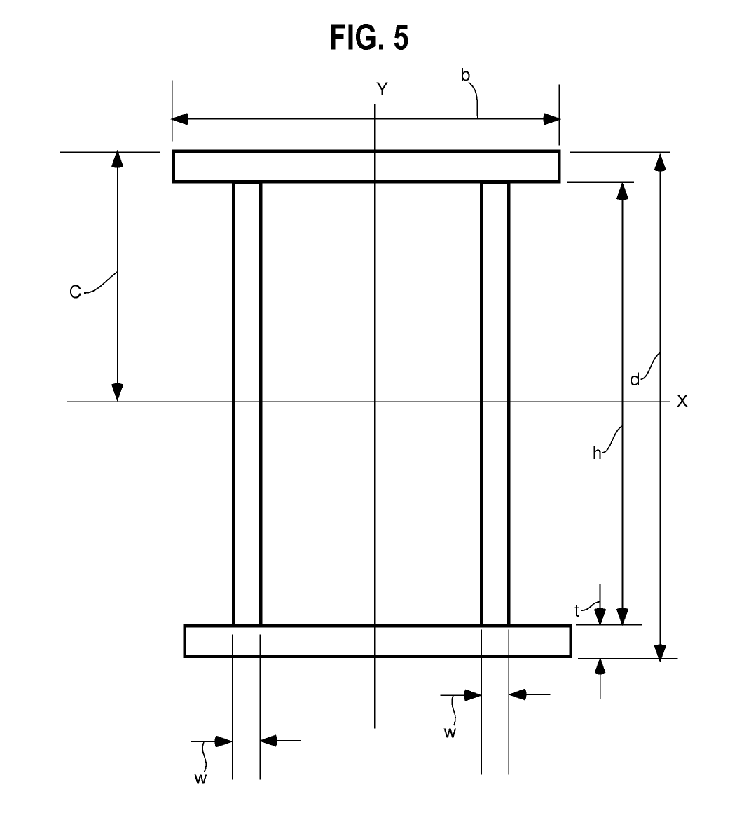

I=Mc/f (1)

where M is the load moment on a cross section of the rigidly-connected portions of the truck and c is the distance from the neutral axis of the cross section to a farthest point of the cross section along dimensions x and y from the neutral axis (otherwise referred to as the extreme fiber). Thus, for example, in the case of a truck assumed (at least initially) to comprise a box girder 80 as seen in FIG. 5 that is to be loaded during operation of the crane, the box girder 80 has a moment of inertia I at the illustrated cross section about axes x-x and y-y using the dimensions in such FIG. equal to:

I=(2)(1/12)(w)(h³)+(2)(1/12)(b)(t³)+(2)(b)(t)(d/2−t/2)² (2)

The load moment M is calculated from the loads to be applied to the truck using any known calculation method. Thereafter, using equation (1) above, the actual stress magnitude f that will be experienced at the cross section of the truck is calculated as:

f=Mc/I (3)

The actual stress magnitude is then compared to a particular maximum magnitude of allowable stress and, if necessary, the design of the truck is modified (for example, by changing the cross sectional or other shape of the truck and/or by adding one or more plates 42 atop surface 40 as noted previously) and the foregoing calculations are repeated. Again, if necessary, one or more further design modifications and further calculations may be iteratively repeated as noted above until the maximum magnitude of allowable stress exceeds the actual stress by a predetermined amount or amounts over the full dimensions of the truck. This results in a truck design that has a load bearing member (e.g., the box girder of FIG. 5) and one or more additional structures rigidly coupled thereto (e.g., the frame) that have at least a predetermined moment of inertia sufficient to achieve the desirable substantially equal wheel loadings.

Further, in an embodiment, the combination of the load bearing member and other structures rigidly coupled thereto (e.g., the frame) of each truck 26a, 26b, 52, 54 has a stiffness S (i.e., resistance to bending) for a given stress magnitude f of at least:

S=M/f (2)

where S=I/c (3)

As noted previously in connection with FIG. 4, the first and second bridge girders 12, 14 may be supported over the full lengths thereof such that neither girder 12, 14 has a cantilevered portion. Thus, for example, the supports 16a, 16b, 18a, and 18b may be disposed at ends of the bridge girders 12, 14. The crane may otherwise be identical to the crane 10.

### INDUSTRIAL APPLICABILITY

As noted above, the moment of inertia of each end truck is great enough so as to limit deflection of the trucks 26a, 26b, 52, and 54 and create a rigid support that allows each wheel of the pluralities of wheels 28, 55, and 56 to support an equal load. In one embodiment, one or more plate of a given thickness and/or other member is added to the truck so as to increase the mass of the truck, and thereby increase its moment of inertia. This results in the ability to reduce the amount of material in each beam leading to reduced costs.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

We claim:

1. A supporting truck for a crane, comprising:
a load bearing member;
a frame rigidly coupled to the load bearing member; and
a plurality of substantially equally spaced and substantially equally sized wheels rigidly journaled in the frame at substantially equal heights such that the wheels have a single degree of freedom comprising rotational movement with respect to the frame and the load bearing member;
wherein the load bearing member and the frame have at least a particular moment of inertia to cause the wheels to experience substantially equal loading by forces applied to the load bearing member.

2. The supporting truck of claim 1, wherein the load bearing member comprises a support platform.

3. The supporting truck of claim 1, in combination with a bridge girder extending between a pair of supports having a cantilevered portion of length L extending from one of the supports and terminating at an end thereof.

4. The supporting truck of claim 3, wherein the cantilevered portion is about at least 50 feet in length.

5. The supporting truck of claim 4, wherein the pair of supports are in contact with a surface.

6. The supporting truck of claim 4, wherein the bridge girder extends at least about 200 feet between the pair of supports.

7. The supporting truck of claim 1, in combination with first and second spaced bridge girders and a trolley girder extending transversely between the first and the second spaced bridge girders wherein an end of the trolley girder is supported by the end truck.

8. The supporting truck of claim 7, wherein first and second ends of the trolley girder are supported by first and second end trucks.

9. The supporting truck of claim 1, wherein the load bearing member and the frame have a moment of inertia I at least equal to:
I=Mc/f
where M is a load moment on a particular cross section of the load bearing member, c is a distance from a neutral axis of the particular cross section to an extreme fiber of the particular cross section, and f is a given stress magnitude.

10. The supporting truck of claim 1, wherein the standard deviation of the loads on the plurality of wheels is less than or equal to 2%.

11. The supporting truck of claim 1, wherein each of the plurality of wheels has a diameter of about 15 inches and is journaled at a location spaced from a journaling location of an adjacent wheel by no more than about 1.5 feet.

12. The supporting truck of claim 1, in combination with a bridge girder that extends between a pair of supports wherein the end truck is movable along a range of positions between and not outside the pair of supports.

13. A crane, comprising:
first and second spaced bridge members wherein each bridge member extends between an associated pair of supports and the bridge members are parallel to one another;
first and second spaced trolley girders;
a movable trolley disposed on the trolley girders;
first and second end trucks supporting first and second ends, respectively, of the first and second trolley girders wherein the trolley girders extend transversely with respect to the bridge members;
wherein each of the first and second end trucks includes a load bearing member, a frame rigidly coupled to the load bearing member, and a plurality of substantially equally spaced and substantially equally sized wheels rigidly journaled in the frame at substantially equal heights such that the wheels have a single degree of freedom comprising rotational movement with respect to the frame and the load bearing member, and wherein the load bearing member and the frame have a moment of inertia I at least equal to Mc/f, where M is a load moment on a particular cross section of the load bearing member, c is a distance from a neutral axis of the particular cross section to an extreme fiber of the particular cross section, and f is a given stress magnitude, to cause the wheels to experience substantially equal loading by forces applied to the load bearing member.

14. The crane of claim 13, wherein the load bearing member comprises a box girder.

15. The crane of claim 13, wherein each bridge girder has a cantilevered portion of length L extending from one of the associated pair of supports and terminating at an end thereof, wherein the first and second end trucks are movable along and associated with the first and second bridge girders, respectively.

16. The crane of claim 15, wherein each cantilevered portion is about at least 50 feet in length.

17. The crane of claim 16, wherein the bridge girder extends at least about 200 feet between the pair of supports.

18. The crane of claim 13, wherein the supports are in contact with a ground surface.

19. The crane of claim 13, wherein the load bearing member has a stiffness S of at least M/f.

20. The crane of claim 13, wherein the standard deviation of the loads on each plurality of wheels is less than or equal to 2%.

21. The crane of claim 13, wherein each of the wheels has a diameter of about 15 inches and is journaled at a location spaced from a journaling location of an adjacent wheel by no more than about 1.5 feet.

22. The crane of claim 13, wherein each end truck is movable along a range of positions between and not outside the associated pair of supports.

23. The crane of claim 13, wherein at least one metallic plate is secured to the end truck so as to increase the weight and moment of inertia of the end truck.
